(19) United States
(12) Patent Application Publication
(10) Pub. No.: US 2023/0182755 A1
(43) Pub. Date: Jun. 15, 2023

(54) SYSTEM AND METHOD FOR PROVIDING LONGITUDINAL CONTROL BY LOCKING THROTTLE PEDAL

(71) Applicant: TOYOTA RESEARCH INSTITUTE, INC., Los Altos, CA (US)

(72) Inventors: Manuel Ludwig Kuehner, Mountain View, CA (US); Daniel J. Brooks, Arlington, MA (US); Hiroshi Yasuda, San Francisco, CA (US); Jaime Camhi, San Jose, CA (US)

(21) Appl. No.: 17/547,056

(22) Filed: Dec. 9, 2021

(51) Int. Cl. B60W 50/12; B60W 30/09; B60W 30/16; F16D 57/00; G09B 19/16

(52) U.S. Cl. CPC B60W 50/12; B60W 30/09; B60W 30/16; F16D 57/002; G09B 19/167; B60W 2540/10; B60W 2554/4041; B60W 2520/10; B60W 2554/4042; B60W 2554/802; B60W 2754/30; B60W 2420/52; B60W 2420/42; B60W 2420/54

(57) ABSTRACT

Systems and methods are provided for improved collision prevention. Systems and methods may provide for the prevention of rear-end vehicle collisions by locking the forward movement of the throttle pedal when a threshold is reached. An end stop or mechanical linkage may completely lock the throttle pedal in situations in which continued acceleration is likely to result in a rear-end collision. The systems and methods disclosed herein may provide from a complete locking of the throttle pedal which may physically avoid or eliminate a rear-end collision due to improper throttle actuation. The systems and methods disclosed herein may also improve a driver's mental model for safe driving by teaching a driver that certain maneuvers are not available in certain conditions.

### TECHNICAL FIELD

The present disclosure relates generally to collision prevention systems and methods, and in particular, some implementations may relate to preventing rear-end vehicle collisions by locking the forward movement of the throttle pedal when a threshold is crossed.

### DESCRIPTION OF RELATED ART

Collisions, and in particular, rear-end collisions, pose a significant driving risk. Drivers must carefully regulate their speed to avoid colliding with a leading vehicle or object on a road region. In order to regulate speed, drivers must account for not only their own speed, the speed of the leading object or vehicle, and any roadway conditions that may affect the driver's ability to slow down or stop. Regulating speed is an extremely difficult task in many situations. For example, a driver may struggle to slow down or stop in time if the preceding object or vehicle stops or reduces speed at an unexpected time or with unexpected force. Additionally, roadway conditions such as inclement weather, including rain and ice, poor visibility, rough terrain, dense traffic, and other conditions, may also impede the driver's ability to regulate speed to avoid a collision with the leading vehicle or object.

When an ego vehicle is driven directly behind a leading vehicle or object, there is a threshold (such as a safety threshold) under which a driver of the ego vehicle will be unable to avoid a collision with the leading vehicle or object if the leading vehicle or object unexpectedly stops or abruptly slows down. This threshold can be considered a physical distance separating a leading object or vehicle from the ego vehicle. This threshold may also be expressed as the amount of time it would take the ego vehicle to come within the threshold distance traveling at its current speed.

Current systems may provide warnings to the driver of the ego vehicle when the distance between a leading object or vehicle and the ego vehicle falls below the safety threshold or when some other unsafe condition is recognized. In some embodiments, systems use audible and/or visual warnings to alert the driver of the unsafe conditions. For example, some vehicles may be configured to emit a warning sound and visual when the ego vehicle is approaching a detected object or obstacle too quickly to avoid a collision. Some systems make use of haptic warnings as an alternative to or in addition to audible and visual warnings. For instance, a system may be configured to provide mild force feedback on the throttle if the system determines the driver is at risk of a rear-end collision.

However, the driver may elect to overcome or disregard any of these warnings and continue driving, despite a high risk of a dangerous collision. For instance, in the above-described haptic warning based system, a driver could overcome the mild force feedback on the throttle by applying greater force to the throttle to continue accelerating. Similarly, a driver may ignore the audible or visual warning and continue accelerating. None of these systems completely eliminate the possibility of the driver violating a safety threshold.

### BRIEF SUMMARY OF THE DISCLOSURE

According to various embodiments of the disclosed technology a collision prevention method may include determining a safe driving envelope, detecting an ego vehicle entering a limit of the safe driving envelope, and locking depression of a throttle pedal of the ego vehicle upon detection of the ego vehicle entering the limit of the safe driving envelope. The method may also include detecting the ego vehicle exiting the safe driving envelope and unlocking depression of the throttle pedal upon detection of the ego vehicle exiting the safe driving envelope.

A safe driving envelope may refer to scenarios in which the physical distance separating an ego vehicle and an object in front of the vehicle is sufficient such that if the object in front of the vehicle abruptly and/or unexpectedly slows down or stops, the ego vehicle has sufficient time and/or distance to stop without colliding with the object in front of the ego vehicle.

The method may also include detecting an object associated with the safe driving envelope. The safe driving envelope in a situation including an object may include a set of physical separation distances between the ego vehicle and the object enabling the ego vehicle to avoid a collision between the ego vehicle and the object. The object may be a leading vehicle. The leading vehicle may share a road region with the ego vehicle. The leading vehicle may directly precede the ego vehicle in the same lane of the road region.

In a collision prevention method, the limit of the safe driving envelope may be expressed as a time to time to collision (“TTC”) threshold. A TTC measurement may consider the relative speeds of both the ego vehicle and the leading vehicle or object. In a collision prevention method, the limit of the safe driving envelope may be expressed as a time headway (“THW”) threshold. A THW measurement may consider only the absolute speed of the ego vehicle.

In a collision prevention method, determining a safe driving envelope may be based on relevant parameters. These parameters may include a speed of the ego vehicle, a speed of the leading vehicle, a physical distance separating the ego vehicle and the leading vehicle, and other relevant parameters.

A collision prevention method may also involve adjusting the limit of the safe driving envelope based on external conditions. External conditions may include the presence of a preceding vehicle or object, the location of a preceding vehicle or object, the speed of the preceding vehicle or object, road conditions, road curvature, obstacles, road grade, and other conditions.

A collision prevention apparatus may include a sensor system, a switch endstop, and a vehicle equipped with the sensor system and the switch endstop. The switch endstop may include a configuration that enables locking a throttle pedal. Upon detection of a violation of a safe driving threshold condition by the sensor system, the switch endstop may increase passive resistance of the throttle pedal to the force applied by a driver of the vehicle to reduce movement of the throttle pedal of the vehicle in response to the force. Upon detection of a violation of a safe driving threshold condition by the sensor system, the switch endstop may increase passive resistance of the throttle pedal to the force applied by a driver of the vehicle to lock movement of the throttle pedal of the vehicle in response to the force.

The sensor system of the apparatus may be configured to measure the force applied by the driver to the throttle pedal. The sensor system of the apparatus may also include external sensors configured to detect road conditions outside the vehicle.

In an embodiment, the switch endstop of the apparatus may include a cylinder configured below the throttle pedal such that, in a first position, the cylinder does not contact the throttle pedal, enabling both depression and release of the throttle pedal, and, in a second position, the cylinder contacts the throttle pedal, preventing the depression of the throttle pedal.

In an embodiment, the switch endstop of the apparatus may include a chamber filled with magnetorheological fluid (“MRF”) configured below the throttle pedal such that, in a first state the fluid enables both depression and release of the throttle pedal, and, in a second state the fluid prevents depression of the throttle pedal.

A safe driving teachings system may include a sensor array, a processor connected to the sensor array, a point-of-control locking feedback module connected to the processor, and a memory storing instructions. When executed by the processor, the instructions may cause the sensor array to detect an object in front of an ego vehicle to determine a safety time gap between the ego vehicle and the object, the point-of-control locking feedback module to enter a lock mode when the ego vehicle reaches the limit of the safety time gap, and the system to instruct the driver of the ego vehicle, by locking the ego vehicle at the point of control, that an attempted maneuver is not available. A safety time gap may represent the safe following distance between the ego vehicle and the leading vehicle or object.

The sensor array in a safe driving teaching system may include radar, sonar, camera, and LIDAR sensors. In a safe driving teaching system, the object may be a leading vehicle. The processor in a safe driving teaching system may detect when a vehicle enters the safety time gap.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for a collision prevention system in accordance with one embodiment of the systems and methods described herein.

FIG. 3 is an example computing component that may be used to implement various features of embodiments described in the present disclosure.

FIG. 4 is an example of a flow diagram showing a collision prevention method in accordance with one embodiment of the systems and methods described herein.

FIG. 5 illustrates an example scenario in which a collision prevention system may be activated in accordance with one embodiment of the systems and methods described herein.

FIG. 6A illustrates an example of a collision prevention system in accordance with one embodiment of the systems and methods described herein.

FIG. 6B illustrates an example of a collision prevention system in accordance with one embodiment of the systems and methods described herein.

FIG. 7A illustrates an example of a collision prevention system in accordance with one embodiment of the systems and methods described herein.

FIG. 7B illustrates an example of a collision prevention system in accordance with one embodiment of the systems and methods described herein.

The figures are not exhaustive and do not limit the present disclosure to the precise form disclosed.

### DETAILED DESCRIPTION

Embodiments of the systems and methods disclosed herein can provide improved collision prevention. In particular, these systems and methods may provide for the prevention of rear-end vehicle collisions by locking the forward movement of the throttle pedal when a threshold is crossed. An end stop or mechanical linkage may completely lock the throttle in situations in which continued acceleration is likely to result in a rear-end collision. These systems and methods may be particularly advantageous because they may physically avoid or eliminate a risk of a rear-end collision due to improper throttle actuation in a dangerous situation. Additionally, these systems and methods may improve a driver's mental model for safe driving by teaching the driver that certain maneuvers are not available in certain conditions.

A driver of an ego vehicle may regulate their speed to avoid colliding with a leading vehicle or object on a road region. To regulate speed, the driver may account for not only the speed of the ego vehicle but also the speed of the leading object or vehicle and any roadway conditions that may affect the driver's ability to slow down or stop. Failure to regulate speed of the ego vehicle may result in a rear-end collision by which the ego vehicle strikes the leading object or vehicle. For example, if the driver of the ego vehicle continues to activate the throttle when approaching the leading vehicle or object, the driver may struggle to slow down or stop in time if the preceding object or vehicle stops or reduces speed at an unexpected time or with unexpected force. Thus, the ego vehicle may collide with the leading vehicle or object. Additionally, roadway conditions such as inclement weather, including rain and ice, poor visibility, rough terrain, dense traffic, and other conditions may impede a driver's ability to regulate speed to avoid a collision with the leading vehicle or object.

When the ego vehicle is driven directly behind the leading vehicle or object there may be a threshold distance between the ego vehicle and the leading vehicle or object such that if the distance between the ego vehicle and the leading vehicle or object were to fall under the threshold distance, there may be an increased risk of a rear-end collision between the ego vehicle and the leading vehicle or object as compared to if the distance is greater than or equal to the threshold distance. The driver of the ego vehicle may be unable to avoid a rear-end collision if the distance between the ego vehicle and the leading vehicle or object falls under the threshold distance and the leading vehicle or object were to brake at an unexpected time or with unexpected force and/or abruptness.

The point at which it becomes unsafe to accelerate the ego vehicle may be expressed in a number of different ways. For example, it may be expressed as a physical distance threshold separating the leading object or vehicle from the ego vehicle, under which the ego vehicle would not be able to avoid a collision with the leading vehicle or object if the leading vehicle or object were to brake unexpectedly. This point may also be expressed as a time gap. The time gap may represent the amount of time it would take the ego vehicle to cover the distance between the leading vehicle or object if the ego vehicle were to continue traveling at its current speed and the leading vehicle or object were to continue traveling and its current speed. If the leading vehicle or object were traveling at the same speed or faster than the ego vehicle, the time gap may be considered infinite as the ego vehicle would never catch up to the leading vehicle or object unless the ego vehicle and/or leading vehicle or object were to change speed. If the leading vehicle or object were traveling at a speed slower than the ego vehicle, the time gap may decrease as the distance between the ego vehicle and the leading vehicle or object decreases.

Like the threshold physical distance discussed above, there may be a threshold time gap that represents the limit of safety for the ego vehicle at any given speed. If the ego vehicle were to reduce this time gap, the driver of the ego vehicle may not be able to slow down or stop in sufficient time to prevent a collision with the leading vehicle or object if the leading vehicle or object were to unexpectedly and/or forcefully stop or reduce speed. The time gap may be expressed as a time to collision (“TTC”) measurement. A TTC measurement may consider the relative speeds of both the ego vehicle and the leading vehicle or object. The time gap may also be expressed as a time headway (“THW”) measurement. A THW measurement may consider only the absolute speed of the ego vehicle.

The distance threshold or time gap may vary depending on the speed of the ego vehicle, the speed of the leading vehicle or object, and road conditions. For example, if road conditions are ideal, the time gap may not need to be adjusted beyond a measurement considering the speeds of the ego vehicle and the leading vehicle or object and the distance between the ego vehicle and the leading vehicle or object. However, if road conditions pose additional risks, the safety time gap may be reduced accordingly. For example, dangerous weather conditions that decrease friction on the road such as ice, snow, rain, and sleet may warrant adjusting the safety time gap.

In the systems and methods disclosed herein, the throttle of the ego vehicle may physically lock when the ego vehicle reaches the limit of the distance threshold or safety time gap. Locking the throttle may eliminate the possibility of continued acceleration of the ego vehicle, preventing the driver of the ego vehicle from violating the distance threshold or safety time gap representing the safe following distance between the ego vehicle and the leading vehicle or object. Locking the throttle may prevent the ego vehicle from increasing its speed in violation of the safety time gap by preventing the ego vehicle from accelerating beyond the speed of the leading vehicle or object when the time gap is already at the limit of the safety envelope.

In addition to the above-described scenario, a system and/or method including throttle locking may also physically prevent an accident when a driver inadvertently accelerates an ego vehicle, is not paying attention to the road, or is exercising poor judgment. The driver who is inattentive, accidently accelerates, or has poor judgment may override a mild force feedback warning, or ignore a visual or audible warning, which may result in a collision. A locking throttle pedal may also reduce the workload of the driver of the ego vehicle when following a leading vehicle or object in dense traffic conditions and/or for a sustained period of time. The driver may rest their feet on the locked throttle pedal, which may increase comfort, and may also reduce the mental load of the driver, leaving the driver more refreshed and alert and better equipped to drive safely during the remainder of their journey.

A throttle locking system or method may provide feedback to a driver of an ego vehicle at the point of control of the ego vehicle. Providing feedback at the point of control may improve a driver's muscle memory and may help a driver build an intuitive sense of which maneuvers are safe/unsafe under which conditions. Visual and/or audible warnings may be used to alert a driver to a potential collision. For example, a visual or audible warning may alert a driver that unless the driver reduces speed, the driver is on a trajectory that will result in a collision with a preceding vehicle. Visual and/or audible warnings may also indicate to a driver that if the driver continues to accelerate, the driver will reach a speed and/or distance at which the driver will be unable to avoid a collision with a preceding vehicle if the preceding vehicle were to abruptly stop or slow down. Visual and audible warnings may not have the same effect because a driver may perceive visual and/or audible warnings independently from the driver's operation of the ego vehicle. Visual and audible warnings may persist without any affect or connection to the driver's ability to operate the ego vehicle and thus may more easily be ignored.

A throttle lock feature coupled with a safety threshold may indicate to a driver not only that a maneuver is potentially unsafe or risky but that a maneuver is not available because of the high likelihood it would result in a dangerous collision given the present conditions. This may improve a driver's mental model by teaching drivers which maneuvers are and are not available in particular conditions. Weak force feedback, which the driver may choose to ignore and overcome, may not have the same effect because the driver may not learn that the maneuver is unavailable, only that it is inadvisable. When the driver chooses to overcome weak force feedback and continues to accelerate and no accident occurs, this process may reinforce that such a maneuver is available. In actuality, the maneuver may be extremely dangerous and have a high probability of resulting in a collision. A locking mechanism may teach the driver the maneuver is not available without the driver having to experience a collision to understand the degree of risk. Specifically, in a gas-by-wire system, a driver may understand that the pedal controls movement of the vehicle. The driver may understand that if the pedal is depressed, the car will accelerate and if the pedal is released, the car will slow down. The driver may understand that preventing depression of the pedal prevents acceleration of the vehicle. In this way, locking depression of the throttle pedal may create an immediate mental model indicating acceleration is not allowed because it is not safe.

In one example embodiment, a safety system may mounted within the ego vehicle. The system may include a processor connected to a vehicle perception system. The vehicle perception system may include sensors. The sensors may be radar, sonar, camera, LIDAR, and other types of sensors. The vehicle perception system may detect objects and vehicles. The vehicle perception system may then determine a safety time gap between the ego vehicle and another object. The other object may be, for example, a leading vehicle. When the ego vehicle has entered the safety time gap, the system may lock the forward movement of the throttle pedal.

Systems and methods disclosed herein may include a physical prevention mechanism which creates an end stop on the throttle pedal wholly preventing a driver of an ego vehicle from continuing to accelerate the ego vehicle when the ego vehicle is at the limit of a threshold condition. The forward movement of the throttle pedal may be locked by using one or more mechanical linkages or end stops that physically prevent forward movement of the throttle pedal. The ego vehicle may also be equipped with a device to measure the force being applied by the driver and a mechanism to increase the passive resistance of the pedal to this force such that it prevents the forward movement of the vehicle pedal. This could be achieved in several ways. This could be achieved, for example, by using magnetorheological fluids (“MRF”) based dampers.

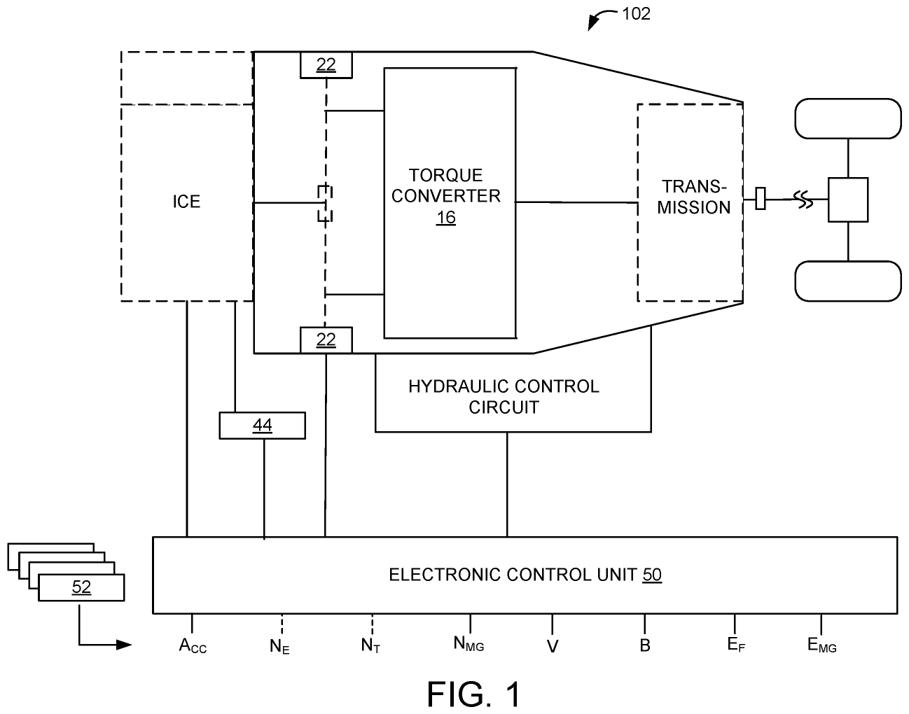

The systems and methods disclosed herein may be implemented with any of a number of different vehicles and vehicle types. For example, the systems and methods disclosed herein may be used with automobiles, trucks, motorcycles, recreational vehicles, and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for collision prevention can be implemented in other types of vehicle including gasoline- or diesel-powered vehicles, fuel-cell vehicles, electric vehicles, or other vehicles.

Vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, a throttle control module, a sensor control module, and so on. As a further example, electronic control units can be included to control systems and functions such as doors and door locking, lighting, human-machine interfaces, cruise control, telematics, braking systems (e.g., ABS or ESC), battery management systems, throttle actuation, sensor actuation, and so on. These various control units can be implemented using two or more separate electronic control units or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MS}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 102 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, radar, sonar, camera, LIDAR, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, a preceding vehicle or object, the speed of the preceding vehicle or object, road conditions, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as examples of vehicle systems with which embodiments of the disclosed technology may be implemented. One of ordinary skill in the art reading this description will understand how the disclosed embodiments can be implemented with vehicle platforms.

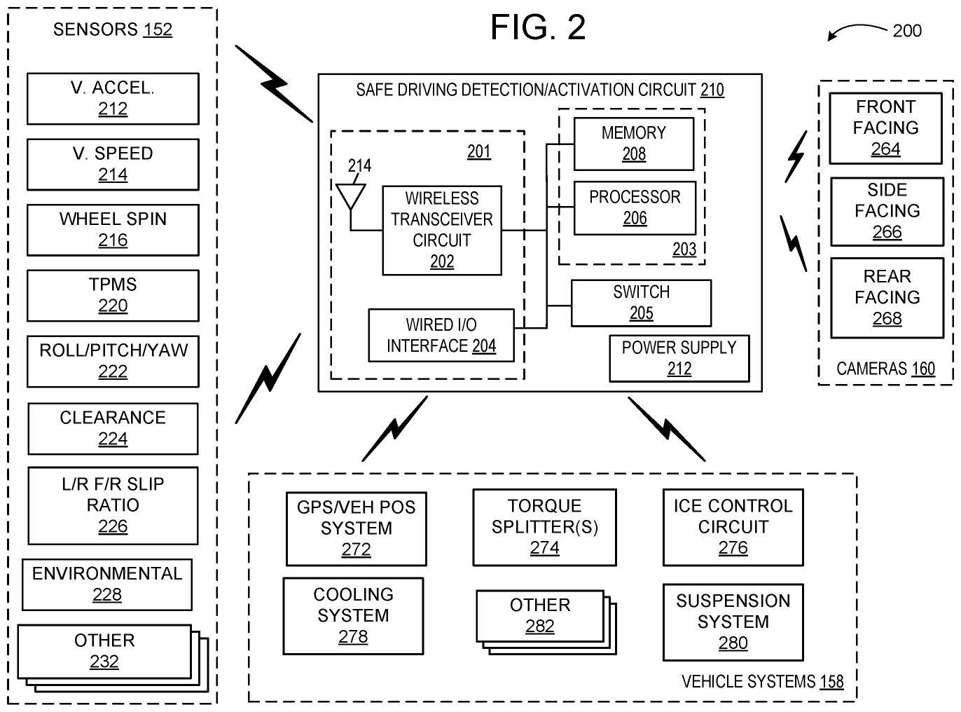

FIG. 2 illustrates an example architecture for collision prevention in accordance with one embodiment of the systems and methods described herein. Referring now to FIG. 2, in this example, collision prevention system 200 includes a safe driving detection/activation circuit 210, a plurality of sensors 152, a plurality of vehicle systems 158, and a plurality of cameras 160. Sensors 152, vehicle systems 158, and cameras 160 can communicate with safe driving detection/activation circuit 210 via a wired or wireless communication interface. Although sensors 152, vehicle systems 158, and cameras 160 are depicted as communicating with safe driving detection/activation circuit 210, they can also communicate with each other as well as with other vehicle systems. Safe driving detection/activation circuit 210 can be implemented as an ECU or as part of an ECU such as, for example electronic control unit 50. In other embodiments, safe driving detection/activation circuit 210 can be implemented independently of the ECU.

Safe driving detection/activation circuit 210 in this example includes a communication circuit 201, a decision circuit 203 (including a processor 206 and memory 208 in this example) and a power supply 212. Components of safe driving detection/activation circuit 210 are illustrated as communicating with each other via a data bus, although other communication in interfaces can be included. Safe driving detection/activation circuit 210 in this example also includes a manual switch 205 that can be operated by the user to manually select the safe driving mode.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions, and variables for processor 206 as well as any other suitable information. Memory 208 can be made up of one or more modules of one or more different types of memory, and may be configured to store data and other information as well as operational instructions that may be used by the processor 206 to safe driving detection/activation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a safe driving detection/activation circuit 210.

Communication circuit 201 may include either or both a wireless transceiver circuit 202 with an associated antenna 214 and a wired I/O interface 204 with an associated hardwired data port (not illustrated). As this example illustrates, communications with safe driving detection/activation circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by safe driving detection/activation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 52 can include additional sensors that may or not otherwise be included on a standard vehicle 10 with which the collision prevention system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect preceding vehicles or objects or other environmental conditions). Additional sensors 232 can also be included as may be appropriate for a given implementation of collision prevention system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 they can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, and other vehicle systems.

During operation, safe driving detection/activation circuit 210 can receive information from various vehicle sensors 152 to determine whether the safe driving mode should be activated. Also, the driver may manually activate the safe driving mode by operating assists which 205. Communication circuit 201 can be used to transmit and receive information between safe driving detection/activation circuit 210 and sensors 152, and safe driving detection/activation circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining whether to activate the safe driving mode. Additionally, communication circuit 201 can be used to send an activation signal or other activation information to various vehicle systems 158 as part of entering the safe driving mode. For example, as described in more detail below, communication circuit 201 can be used to send signals to, for example, one or more of: torque splitters 274 to control front/rear torque split and left/right torque split; motor controllers 276 to, for example, control motor torque, motor speed of the various motors in the system; ICE control circuit 276 to, for example, control power to engine 14 (e.g., to shut down the engine so all power goes to the rear motors, to ensure the engine is running to charge the batteries or allow more power to flow to the motors); cooling system (e.g., 278 to increase cooling system flow for one or more motors and their associated electronics); suspension system 280 (e.g., to increase ground clearance such as by increasing the ride height using the air suspension). The decision regarding what action to take via these various vehicle systems 158 can be made based on the information detected by sensors 152. Examples of this are described in more detail below.

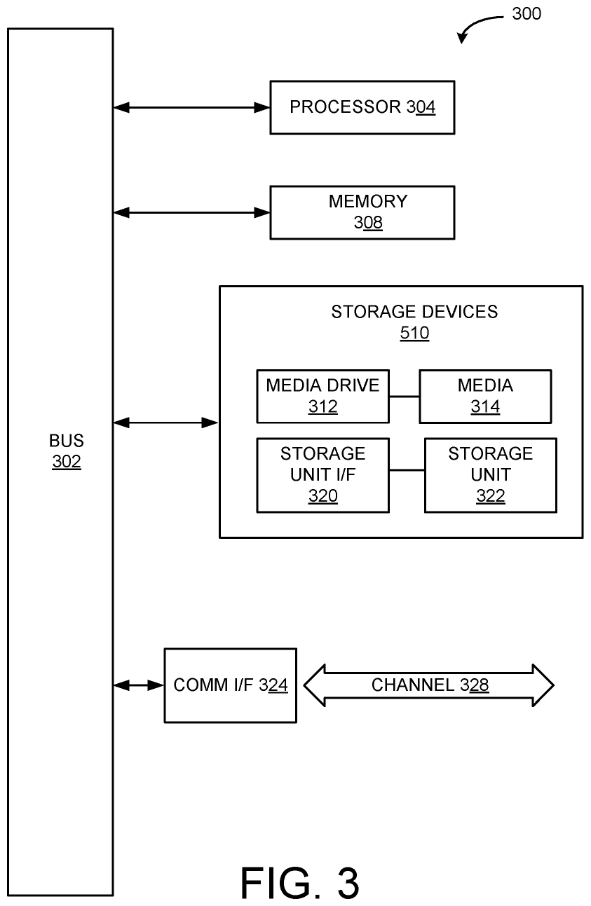

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 3. Various embodiments are described in terms of this example-computing component 300. After reading this description, it will become apparent to a person skilled in the relevant art how to implement the application using other computing components or architectures.

Referring now to FIG. 3, computing component 300 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 300 might also represent computing capabilities embedded within or otherwise available to a given device. For example, a computing component might be found in other electronic devices such as, for example, portable computing devices, and other electronic devices that might include some form of processing capability.

Computing component 300 might include, for example, one or more processors, controllers, control components, or other processing devices. Processor 304 might be implemented using a general-purpose or special-purpose processing engine such as, for example, a microprocessor, controller, or other control logic. Processor 304 may be connected to a bus 302. However, any communication medium can be used to facilitate interaction with other components of computing component 300 or to communicate externally.

Computing component 300 might also include one or more memory components, simply referred to herein as main memory 308. For example, random access memory (RAM) or other dynamic memory, might be used for storing information and instructions to be executed by processor 304. Main memory 308 might also be used for storing temporary variables or other intermediate information during execution of instructions to be executed by processor 304. Computing component 300 might likewise include a read only memory (“ROM”) or other static storage device coupled to bus 302 for storing static information and instructions for processor 304.

The computing component 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a solid-state drive, a magnetic tape drive, an optical drive, a compact disc (CD) or digital video disc (DVD) drive (R or RW), or other removable or fixed media drive might be provided. Storage media 314 might include, for example, a hard disk, an integrated circuit assembly, magnetic tape, cartridge, optical disk, a CD or DVD. Storage media 314 may be any other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing component 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory component) and memory slot. Other examples may include a PCMCIA slot and card, and other fixed or removable storage units 322 and interfaces 320 that allow software and data to be transferred from storage unit 322 to computing component 300.

Computing component 300 might also include a communications interface 324. Communications interface 324 might be used to allow software and data to be transferred between computing component 300 and external devices. Examples of communications interface 324 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 324 may be carried on signals, which can be electronic, electromagnetic (which includes optical) or other signals capable of being exchanged by a given communications interface 324. These signals might be provided to communications interface 324 via a channel 328. Channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 300 to perform features or functions of the present application as discussed herein.

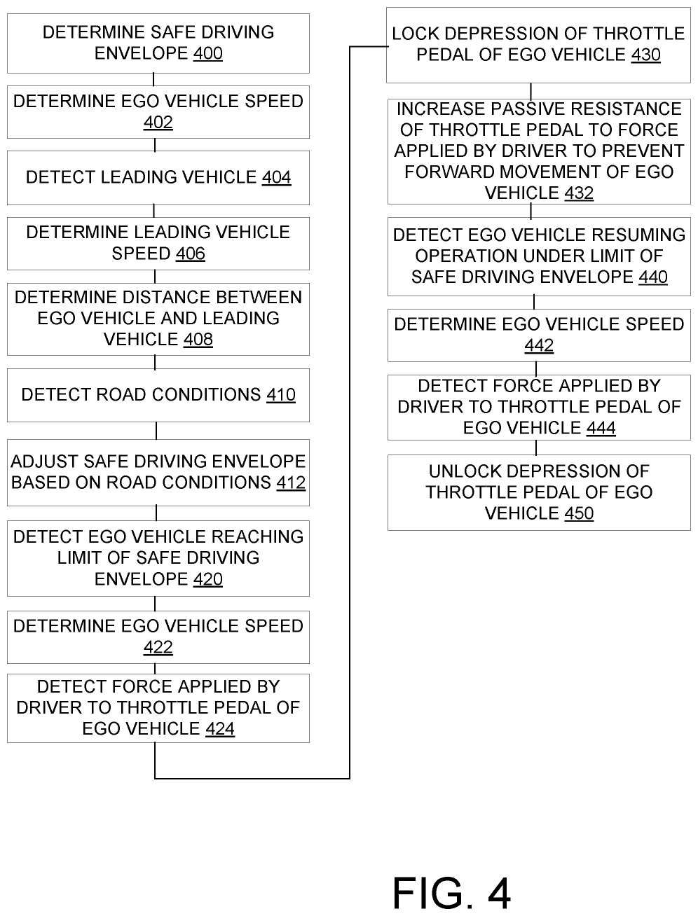

Referring now to FIG. 4, a method for preventing a rear-end collision consistent with one embodiment of the present disclosure is shown. Though FIG. 4 shows several operations 400, 420, 430, 450 together as part of a single flow, can each operation may be individually performed or various combinations of the operations may be performed. Additionally one or more of the suboperations as shown in FIG. 4 may be combined or eliminated. Additional suboperations not shown in FIG. 4 may also be included as part of the flow.

The method may include, as a first operation 400, determining a safe driving envelope. A safe driving envelope may refer to scenarios in which the physical distance separating an ego vehicle and an object in front of the vehicle is sufficient such that if the object in front of the vehicle abruptly and/or unexpectedly slows down or stops, the ego vehicle has sufficient time and/or distance to stop without colliding with the object in front of the ego vehicle.

A first sub-operation 402 to the first operation 400 may comprise determining the speed of the ego vehicle. For example, an ego vehicle may be driving down a road region at a speed A. A second sub-operation 404 to the first operation 400 may include detecting an object. The object in this scenario may be a leading vehicle. A third sub-operation 406 to the first operation 400 may comprise determining the speed of the leading vehicle. The leading vehicle may be traveling down the same road region as the ego vehicle and may be positioned in front of the ego vehicle, for example in a same lane as the ego vehicle. A fourth sub-operation 408 to the first operation 400 may comprise determine the distance separating the ego vehicle and the leading vehicle. The leading vehicle may be traveling at a speed B. If the speed B of the leading vehicle is greater than the speed A of the ego vehicle, then the distance separating the ego vehicle and the leading vehicle will continue to increase. Therefore, the ego vehicle is not at risk of colliding with the leading vehicle and the safe driving envelope may be considered infinite.

Alternatively, the speed A may be greater than the speed B. Thus, the ego vehicle may be closing the distance between the ego vehicle and the leading vehicle. In this scenario, there is a point i at which, if the leading vehicle were to suddenly stop or slow down, the ego vehicle would be unable to slow down in enough time to avoid colliding with the rear-end of the leading vehicle. The point may be a point in time. For instance, if the ego vehicle were to continue its current trajectory at its current speed, there would be a point at time in which the vehicle would be unable to successfully avoid a collision if the leading vehicle braked unexpectedly. The point may also be a physical distance. For instance, if the ego vehicle were to continue its trajectory or to accelerate, it would arrive at a physical distance relative to the leading vehicle such that, if the leading vehicle braked unexpectedly, the ego vehicle would not have enough space to come to a stop before colliding with the leading vehicle.

This point, whether considered as a point in time or a physical distance, represents the limit of the safe driving envelope. The point can be used to create the safe driving envelope. For instance, where the point is expressed as a physical distance, the safe driving envelope may be established by considering all physical distances separating the ego vehicle and the leading vehicle that exceed the physical distance separating the leading vehicle and the ego vehicle at which point the ego vehicle could not avoid a collision if the leading vehicle braked unexpectedly. When the ego vehicle reaches this point, i.e., the physical distance separating the ego vehicle and the leading vehicle at which point the ego vehicle could no longer avoid a collision if the leading vehicle braked unexpectedly, the ego vehicle may exit or reach the limit of the safe driving envelope. The point can be measured in a few different ways. For example, as described above, the point may be expressed as a physical distance separating the ego vehicle and the leading vehicle. If the ego vehicle were to continue travelling at its current speed, A, the point would be the distance at which the ego vehicle could no longer avoid a collision.

The point may also be expressed as a time gap. For example, the limit may be expressed as a time to collision (“TTC”) measurement. A TTC measurement considers both the speed A of the ego vehicle and the speed B of the leading vehicle and represents the time remaining until the vehicles reach a configuration in which the ego vehicle could no longer avoid a collision. The limit may also be expressed as a time headway (“THW”) measurement. A THW measurement considers the absolute speed of the ego vehicle and represents the time it would take the ego vehicle to cover the distance between the ego vehicle and the leading vehicle.

Road conditions may also affect the safe driving envelope. For example, road conditions may include inclement weather such as snow, rain, ice, sleet, and other weather conditions. Weather conditions like these may reduce the friction on the road region and may affect the ego vehicle's ability to slow down or stop. A fifth sub-operation 410 to the first operation 400 may comprise detecting road conditions. The safe driving envelope may need to be adjusted based on detected road conditions because road conditions, such as inclement weather, may affect the ego vehicle's ability to avoid a rear-end collision. A sixth sub-operation 412 to the first operation 400 may include adjusting the safe driving envelope based on detected road conditions.

A method of preventing a rear-end collision may include, as a second operation 420, detecting an ego vehicle reaching the limit of a safe driving envelope. As described above, the limit of the safe driving envelope may be reached when the ego vehicle arrives at a point where it would no longer be able to avoid a collision if the leading vehicle braked unexpectedly. This point may expressed be a physical distance separating the ego vehicle and the leading vehicle, such that if the physical separation distance falls below a threshold, risk of a collision increases. The point may also be expressed as a point in time, such that if the ego vehicle were to continue its current trajectory at its current speed, the point in time would represent the time when the ego vehicle reaches the separation distance threshold. A first sub operation 422 to the second operation 420 may comprise determining the speed of the ego vehicle. A second sub-operation 424 of the second operation 420 may comprise detecting the force applied by the driver of the ego vehicle to the throttle pedal of the ego vehicle. The ego vehicle may be equipped with a mechanism to determine the force applied by the driver to the throttle pedal.

A third operation 430 may comprising locking depression of the throttle pedal of the ego vehicle. A sub-operation 432 to the third operation 430 may include increasing the passive resistance of the throttle pedal to force applied by the driver to prevent forward movement of the ego vehicle. In this way, a collision may be physically prevented. The driver of the ego vehicle may even be able to use the locked throttle pedal as a foot rest in, for example, dense traffic conditions. The locking mechanism, thus, may reduce the workload of the driver.

Increasing passive resistance of the throttle pedal may prevent the driver of the ego vehicle from accelerating the ego vehicle. Therefore, the ego vehicle may not be able to accelerate and thus may not be able to reduce the physical separation distance between the ego vehicle and a leading vehicle or object. The leading vehicle or object, however, may be able to slow down and stop. Therefore, the leading vehicle or object may be able to decrease the physical separation distance between the ego vehicle and the leading vehicle or object. Other features, including, for example, auditory, visual, and/or haptic feedback warnings may alert the driver of the ego vehicle if the leading vehicle or object reduces the physical separation distance. Prevention features, such as automatic braking, may also be used to prevent a collision if the leading vehicle or object slows down or stops. These features may be applied in conjunction with the embodiments disclosed herein.

Additionally, in an embodiment, locking depression of the throttle pedal may prevent depression the throttle pedal downward, i.e., pushing on the throttle pedal which may prevent acceleration of the vehicle. Locking depression of the throttle pedal may not affect, however, release of the throttle pedal by the driver of the ego vehicle. Therefore, a driver may, even if the throttle pedal locks in response to a detected safety violation, continue to increase the physical separation distance between the ego vehicle and the leading vehicle or object by releasing pressure on the throttle pedal.

A fourth operation 440 may include detecting an ego vehicle resuming operation under the limit of the safe driving envelope. The ego vehicle may no longer be at risk of a rear-end collision with the ego vehicle. A first sub-operation 442, of the fourth operation 440 may include determining the speed of the ego vehicle. A second sub-operation 444 of the fourth operation 440 may include detecting the force applied by the driver to the throttle pedal of the ego vehicle. A fifth operation 540 may include unlocking depression of the throttle pedal of the ego vehicle. The driver may then resume acceleration without risk of a dangerous rear-end collision with the leading vehicle.

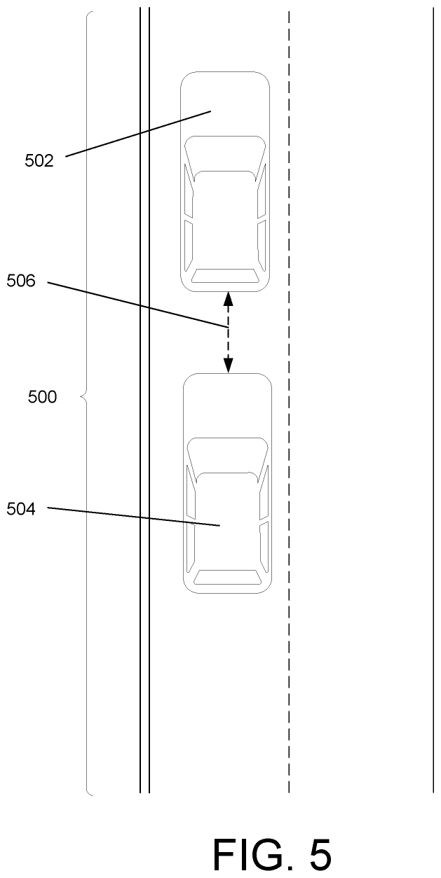

Referring now to FIG. 5, an example of a road region 500 with an ego vehicle 504 and a leading vehicle 502 consistent with an embodiment of the present disclosure is shown. The ego vehicle 504 may be traveling along the road region 500 at a speed A. The leading vehicle 502 may also be travelling along the same road region 500 at a speed B. The leading vehicle 502 may be positioned directly in front of the ego vehicle 504, for example, in a same lane of traffic. This configuration may put the ego vehicle 504 at risk of a rear-end collision with the leading vehicle 502. The ego vehicle 505 and the leading vehicle 502 may be separated by a physical distance 506. The physical distance separating the ego vehicle 504 and the leading vehicle 502 may increase or decrease depending on the speeds of the ego vehicle 504 and the leading vehicle 502. As discussed in the preceding paragraphs, a safe driving envelope may represent situations where the physical distance separating an ego vehicle and an object in front of the vehicle is sufficient such that if the object in front of the vehicle abruptly and/or unexpectedly slows down or stops, the ego vehicle has sufficient time and/or distance to stop without colliding with the object in front of the ego vehicle.

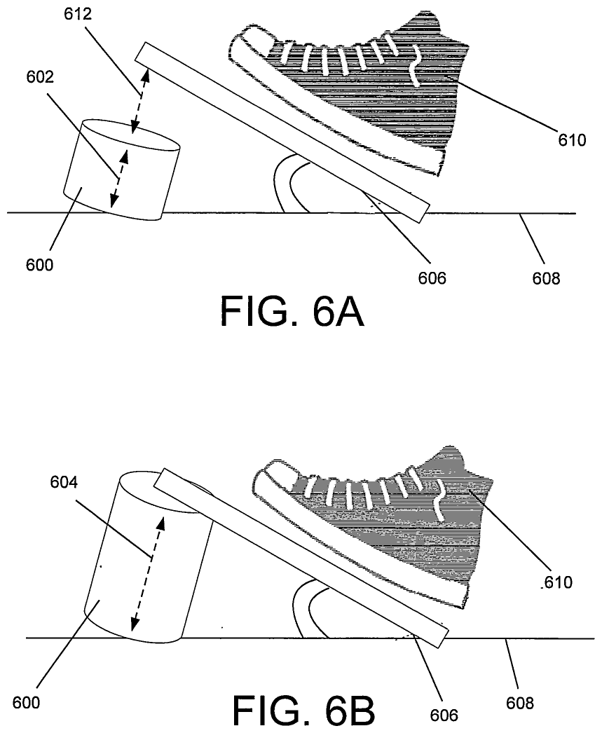

FIGS. 6A and 6B shown an example of a throttle locking mechanism. A throttle locking mechanism may be a cylinder 600. The cylinder may be attached to the floor 608 of a vehicle and positioned under the throttle pedal 606. The cylinder 600 may be configured to expand and retract. For example, in one configuration, such as in FIG. 6A, the cylinder 600 may be retracted. In another configuration, such as in FIG. 6B, the cylinder 600 may be expanded. The cylinder 600 may be expanded or retracted depending on whether the vehicle has reached a limit of the safe driving envelope. For example, the cylinder 600 may expand fully, automatically when the driver has reached the limit of the safe driving envelope. When the vehicle resumes operation within the limit of the safe driving envelope, the cylinder 600 may resume a retracted configuration.

Referring now to FIG. 6A, an example of a configuration in which the cylinder 600 is retracted is shown. In the retracted position, the cylinder 600 does not contact the throttle pedal 606. The driver may apply their foot 610 to the throttle pedal 606 and press down on the throttle pedal 606 to accelerate the vehicle. The cylinder 600 may be retracted such that is has a length 602. The space between the throttle pedal and the cylinder may have a distance 612. This distance enables acceleration of the vehicle.

Referring now to FIG. 6B, an example of a configuration in which the cylinder 600 is expanded is shown. In the expanded position, the cylinder 600 contacts the throttle pedal 606. The driver may apply their foot 610 to the throttle pedal 606 however the driver will be unable to depress the throttle pedal 606 to accelerate the vehicle. The driver may rest their foot on the throttle pedal 606 in this configuration. They cylinder 600 may be expanded to have a length 604. This length 604 may fully occupy the space between the floor and the throttle pedal, preventing the driver from depressing the throttle pedal 606 and accelerating the vehicle.

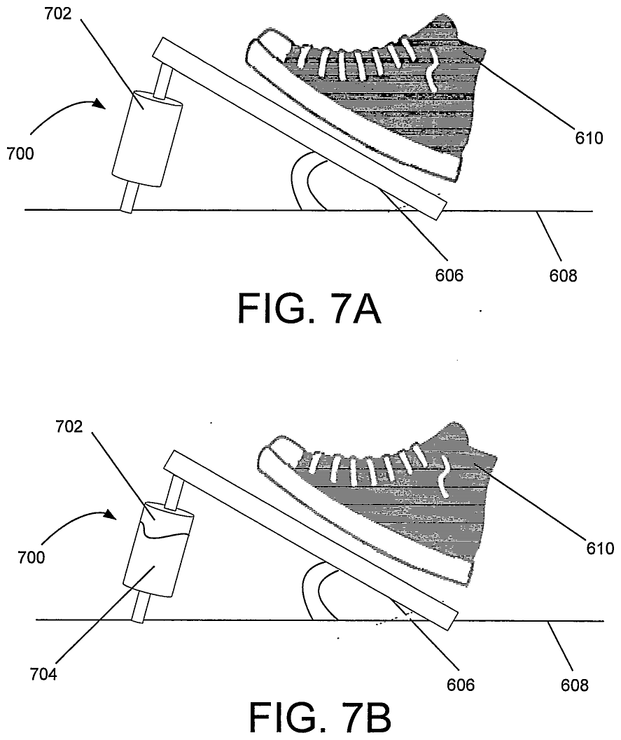

FIGS. 7A and 7B shown an example of a throttle locking mechanism. A throttle locking mechanism may be a cylindrical chamber 700. The cylindrical chamber 700 may be attached to the floor 608 of a vehicle and positioned under the throttle pedal 606. The cylindrical chamber 700 may be configured to occupy an unlocked and locked configuration. For example, in one configuration, the cylindrical chamber 700 may be unlocked. In another configuration, the cylindrical chamber 700 may be locked. The cylindrical chamber 700 may be locked or unlocked depending on whether the vehicle has reached a limit of the safe driving envelope. For example, the cylindrical chamber 700 may lock automatically when the driver has reached the limit of the safe driving envelope. When the vehicle resumes operation within the limit of the safe driving envelope, the cylindrical chamber 700 may resume an unlocked configuration.

Referring now to FIG. 7A, an example of a configuration in which the cylindrical chamber 700 is unlocked is shown. In the unlocked position, the cylindrical chamber 700 may be filled with a magnetorheological fluid (“MRF”). In the unlocked position, a current acting on the cylindrical chamber 700 may be zero. In other words, the cylindrical chamber 700 and fluid may not be exposed to any magnetic field. Therefore, the fluid may occupy a liquid state and may not transmit any force. The driver may apply their foot 610 to the throttle pedal 606 and press down on the throttle pedal 606 to accelerate the vehicle. Because the fluid in the cylindrical chamber 700 is under a current of zero, it does not transmit any force when the driver presses down on the throttle, collapsing the cylindrical chamber 700. This allows the driver to freely depress the throttle pedal and accelerate the vehicle without any impedance.

Referring now to FIG. 7B, an example of a configuration in which the cylindrical chamber 700 is locked is shown. In the locked position, the cylindrical chamber 700 may be filled with a magnetorheological fluid (“MRF”). In the locked position, a current may act on the chamber 700. In other words, the cylindrical chamber 700 and fluid will be exposed to a magnetic field. Under exposure to the magnetic field, the fluid may increase in viscosity, occupying a viscoelastic solid state. In the viscoelastic solid state, the fluid may transmit a force in response to pressure. The driver may apply their foot 610 to the throttle pedal 606 and press down on the throttle pedal 606 to accelerate the vehicle. However, the driver will not be able to successfully accelerate the vehicle because a current is acting on the fluid in the cylindrical chamber 700, increasing the viscosity of the fluid. The viscous fluid may transmit a force in response to the driver pressure which may prevent the cylinder from collapsing when the driver presses on the throttle pedal. The locked cylinder configuration may prevent the driver from accelerating the vehicle.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A collision prevention method comprising:
determining a safe driving envelope;
detecting an ego vehicle entering a limit of the safe driving envelope; and
locking depression of a throttle pedal of the ego vehicle upon detection of the ego vehicle entering the limit of the safe driving envelope.

2. The method of claim 1, further comprising:
detecting the ego vehicle exiting the safe driving envelope; and
unlocking depression of the throttle pedal upon detection of the ego vehicle exiting the safe driving envelope.

3. The method of claim 1, further comprising detecting an object associated with the safe driving envelope, wherein the safe driving envelope comprises a set of physical separation distances between the ego vehicle and the object enabling the ego vehicle to avoid a collision between the ego vehicle and the object.

4. The method of claim 3, wherein the object is a leading vehicle sharing a road region with the ego vehicle and preceding the ego vehicle in a same lane of the road region.

5. The method of claim 1, wherein the limit of the safe driving envelope is a time to collision (“TTC”) threshold.

6. The method of claim 1, wherein the limit of the safe driving envelope is a time headway (“THW”) threshold.

7. The method of claim 4, wherein determining a safe driving envelope is based on parameters selected from the group consisting of: a speed of the ego vehicle, a speed of the leading vehicle, and a physical distance separating the ego vehicle and the leading vehicle.

8. The method of claim 1, further comprising adjusting the limit of the safe driving envelope based on external conditions.

9. A collision prevention apparatus comprising:
a sensor system;
a switch endstop having a configuration which enables locking a throttle pedal; and
a vehicle equipped with the sensor system and switch endstop;
wherein, upon detection of a violation of a safe driving threshold condition by the sensor system, the switch endstop increases passive resistance of the throttle pedal to the force applied by a driver of the vehicle to reduce movement of the throttle pedal of the vehicle in response to the force.

10. The apparatus of claim 9, wherein, upon detection of a violation of a safe driving threshold condition by the sensor system, the switch endstop increases passive resistance of the throttle pedal to the force applied by a driver of the vehicle to lock movement of the throttle pedal of the vehicle in response to the force.

11. The apparatus of claim 9, wherein the sensor system comprises a sensor configured to measure the force applied by the driver to the throttle pedal.

12. The apparatus of claim 9, wherein the sensor system comprises external sensors configured to detect road conditions outside the vehicle.

13. The apparatus of claim 9, wherein the switch endstop comprises a cylinder configured below the throttle pedal such that, in a first position, the cylinder does not contact the throttle pedal, enabling both depression and release of the throttle pedal, and, in a second position, the cylinder contacts the throttle pedal, preventing the depression of the throttle pedal.

14. The apparatus of claim 9, wherein the switch endstop comprises a chamber filled with magnetorheological fluid (“MRF”) configured below the throttle pedal such that, in a first state the fluid enables both depression and release of the throttle pedal, and, in a second state the fluid prevents depression of the throttle pedal.

15. A safe driving teaching system comprising:
a sensor array;
a processor connected to the sensor array;
a point-of-control locking feedback module connected to the processor; and
a memory storing instructions that, when executed by the processor, cause:
the sensor array to detect an object in front of an ego vehicle to determine a safety time gap between the ego vehicle and the object,
the point-of-control locking feedback module to enter a lock mode when the ego vehicle reaches the limit of the safety time gap; and
instruct the driver of the ego vehicle, by locking the ego vehicle at the point of control, that an attempted maneuver is not available.

16. The safe driving teaching system of claim 15, wherein the sensor array comprises radar, sonar, camera, and LIDAR sensors.

17. The safe driving teaching system of claim 15, wherein the object is a leading vehicle.

18. The safe driving teaching system of claim 15, wherein the processor detects when the safety time gap is entered.
